(19) United States
(12) Patent Application Publication
(10) Pub. No.: US 2023/0308935 A1
(43) Pub. Date: Sep. 28, 2023

(54) COMMUNICATION SYSTEM

(71) Applicant: NEC Corporation, Minato-ku, Tokyo (JP)

(72) Inventors: Yuhua CHEN, Surrey (GB); Jagdeep Ahluwalia SINGH, Surrey (GB)

(73) Assignee: NEC Corporation, Minato-ku, Tokyo (JP)

(21) Appl. No.: 17/626,580

(22) PCT Filed: Aug. 26, 2021
(86) PCT No.: PCT/JP2021/031267

§ 371 Date: Jan. 12, 2022

(30) Foreign Application Priority Data
Sep. 11, 2020 (GB) 2014353.3

(51) Int. Cl. H04W 28/02; H04W 16/14

(52) U.S. Cl. CPC H04W 28/0268; H04W 16/14

(57) ABSTRACT

A communication system is disclosed in which data is transmitted using unlicensed spectrum by employing a channel access procedure based on a channel access priority class (CAPC). In order to apply the appropriate CAPC for each transmission in accordance with the actual data flow(s) being multiplexed into the transmission, the CAPC information of each data packet is carried together with the packet down through the user plane protocol.

### TECHNICAL FIELD

The present invention relates to a communication system. The invention has particular but not exclusive relevance to wireless communication systems and devices thereof operating according to the 3rd Generation Partnership Project (3GPP) standards or equivalents or derivatives thereof. The invention has particular, although not necessarily exclusive relevance to channel access in the so-called ‘5G’ (or ‘New Radio’) systems operating with unlicensed spectrum.

### BACKGROUND ART

The latest developments of the 3GPP standards are referred to as ‘5G’ or ‘New Radio’ (NR). These terms refer to an evolving communication technology that supports a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network (NGC).

Under the 3GPP standards, the base station (e.g. an ‘eNB’ in 4G or a ‘gNB’ in 5G) is a node via which communication devices (user equipment or ‘UE’) connect to a core network and communicate to other communication devices or remote servers. For simplicity, the present application will use the term base station to refer to any such base stations.

In the 5G architecture, the gNB internal structure may be split into two parts known as the Central Unit (CU) and the Distributed Unit (DU), connected by an F1 interface. In this ‘split’ architecture, typically ‘higher’, CU layers (for example, but not necessarily or exclusively), PDCP) and the typically ‘lower’, DU layers (for example, but not necessarily or exclusively, RLC/MAC/PHY) may be implemented separately. Thus, for example, the higher layer CU functionality for a number of gNBs may be implemented centrally (for example, by a single processing unit, or in a cloud-based or virtualised system), whilst retaining the lower layer DU functionality locally, in each of the gNB.

For simplicity, the present application will use the term mobile device, user device, or UE to refer to any communication device that is able to connect to the core network via one or more base stations.

Communication devices might be, for example, mobile communication devices such as mobile telephones, smartphones, user equipment, personal digital assistants, laptop/tablet computers, web browsers, e-book readers and/or the like. Such mobile (or even generally stationary) devices are typically operated by a user. However, 3GPP standards also make it possible to connect so-called ‘Internet of Things’ (IoT) devices (e.g. Narrow-Band IoT (NB-IoT) devices) to the network, which typically comprise automated equipment, such as various measuring equipment, telemetry equipment, monitoring systems, tracking and tracing devices, in-vehicle safety systems, vehicle maintenance systems, road sensors, digital billboards, point of sale (POS) terminals, remote control systems, and the like. Effectively, the Internet of Things is a network of devices (or “things”) equipped with appropriate electronics, software, sensors, network connectivity, and/or the like, which enables these devices to collect and exchange data with each other and with other communication devices. It will be appreciated that IoT devices are sometimes also referred to as Machine-Type Communication (MTC) communication devices or Machine-to-Machine (M2M) communication devices.

For simplicity, the present application often refers to mobile devices in the description but it will be appreciated that the technology described can be implemented on any communication devices (mobile and/or generally stationary) that can connect to a communications network for sending/receiving data, regardless of whether such communication devices are controlled by human input or software instructions stored in memory.

5G may be implemented using spectrum allocated to 4G communications (e.g. Long Term Evolution (LTE) or LTE-Advanced) or unlicensed/unallocated spectrum (e.g. 5 GHz and 6 GHz unlicensed bands, all the way up to 60 GHz, also known as mmWave). This scenario is referred to as spectrum sharing and it allows network operators to roll out 5G access technology relatively quickly and cost efficiently. The term ‘NR-U’ refers to NR operation with unlicensed spectrum. Unlicensed spectrum is shared instead of being exclusively used by one operator only.

In order to ensure fair channel sharing and to keep disturbance/interference caused by 5G communications to other communications in the 4G or unlicensed spectrum to a minimum, 5G employs a so-called Listen-Before-Talk (LBT) approach. LBT is a mechanism by which a communication device applies clear channel assessment (CCA) before using the shared spectrum (or channel). When LBT is applied, a transmitter listens to/senses the channel to determine whether the channel is free or busy and performs transmission only if the channel is sensed free. Effectively, a transmitter needs to determine (‘listen’) whether the channel in the shared spectrum is used by another transmitter (e.g. UE or base station), before that transmitter is allowed to transmit (‘talk’) using that channel. Specifically, CCA employs Energy Detection (ED) in order to determine whether the channel is clear or not.

NR operating with shared spectrum channel access can operate in different modes where either PCell, PSCell, or SCells can be in shared spectrum (and it may be configured for downlink only, in case of an SCell). The gNB operates in either dynamic or semi-static channel access mode as described in 3GPP TS 37.213 V16.2.0. In both channel access modes, the gNB and UE may apply LBT before performing a transmission on a cell configured with shared spectrum channel access. 3GPP TS 38.300 V16.2.0 provides further details of the procedures for accessing shared spectrum.

One of the channel access procedure types is called Type 1 channel access procedure. For this channel access procedure, 3GPP defined four channel access priority classes p=1 to 4. A transmission with lower channel access priority class (CAPC) value (i.e. relatively higher priority) normally gets the channel quicker and with higher success probability, but with a shorter maximum channel occupancy time compared to transmissions with a higher CAPC value (relatively lower priority).

Transmissions on the Physical Uplink Shared Channel (PUSCH)/Physical Downlink Shared Channel (PDSCH) may be a mix of control plane data from different signalling radio bearers (SRBs), user plane data from different data radio bearers (DRBs), and/or Medium Access Control (MAC) Control Elements (CEs) added by the MAC layer. The UE (lower layer i.e. PHY/MAC) follows the rules below in order to determine the applicable CAPC of a particular transmission based on the kind of data being multiplexed into that transmission:
Case 1: Highest priority CAPC of MAC CE(s) if only MAC CE(s) are included;
Case 2: Highest priority CAPC of SRBs if SRB Service Data Unit(s) (SDU(s)) are included; and
Case 3: Lowest priority CAPC of the DRBs otherwise.

It will be appreciated that the base station (gNB) will mirror these rules for downlink transmissions.

The CAPC of a DRB is selected by the gNB when the mapping relationship between Quality of Service (QoS) flows and the DRB is decided. Effectively, this is a static relationship since it is determined when setting up the DRB. However, the actual CAPC of a transmission is determined when the data (from a DRB) is multiplexed into a Transport Block (TB). The transmission level CAPC value is thus determined dynamically. As a result, for each DRB (i.e. data packets that belong to that DRB), there are two mapping steps to determine the final CAPC value:
mapping one or multiple QoS flow(s) to a CAPC value at DRB setup; and
mapping the multiplexed SRB/DRB/MAC CE to a CAPC value at transmission.

The inventors have realised that the selected CAPC value of a transmission may not correctly reflect the real QoS flow data multiplexed in the TB, for one or more of the following reasons:
the CAPC of a given DRB is decided by the gNB based on all QoS flows mapped into that DRB;
when two (or more) QoS flows are mapped to a given DRB, with different associated CAPC values, the gNB can configure only one CAPC value for that DRB; and
when the MAC layer multiplexes data from a DRB into a transmission (with other DRB(s)/SRB(s)), it takes the configured CAPC value of that DRB into account, regardless of which QoS flow the data in that transmission belongs to.

This approach may thus result in an incorrect (e.g. higher or lower) CAPC value being applied to some data at the transmission level than the CAPC value required for that data at the QoS flow level.

### SUMMARY OF INVENTION

Accordingly, preferred example embodiments of the present invention aim to provide methods and apparatus which address or at least partially deal with one or more of the above issues.

Although for efficiency of understanding for those of skill in the art, the invention will be described in detail in the context of a 3GPP system (NR), the principles of the invention can be applied to other systems in which communication devices or User Equipment (UE) employ spectrum sharing.

In one example aspect, the invention provides a method performed by a communication apparatus for a channel access procedure relating to communication via an unlicensed spectrum, the method comprising: receiving a data packet forming part of a data flow and forwarding the data packet to a lower layer together with information identifying a first channel access priority class (CAPC) value for the data flow; processing the data packet, at the lower layer, to form a Transport Block for transmission via the unlicensed spectrum; and determining a second CAPC value for the Transport Block based on the information identifying the first CAPC value.

In one example aspect, the invention provides a method performed by a central unit of a base station apparatus for a channel access procedure relating to communication via an unlicensed spectrum, the method comprising: receiving a data packet forming part of a data flow; and forwarding, to a distributed unit handling lower layer processing of the data flow, the data packet together with information identifying a first channel access priority class (CAPC) value for the data flow.

In one example aspect, the invention provides a method performed by a distributed unit of a base station apparatus for a channel access procedure relating to communication via an unlicensed spectrum, the method comprising: receiving, from a central unit of the base station apparatus, a data packet forming part of a data flow, together with information identifying a first channel access priority class (CAPC) value for the data flow; processing the data packet to form a Transport Block for transmission via the unlicensed spectrum; and determining a second CAPC value for the Transport Block based on the information identifying the first CAPC value.

In one example aspect, the invention provides a method performed by a distributed unit of a base station apparatus for a channel access procedure relating to communication via an unlicensed spectrum, the method comprising: receiving, from the central unit, information (e.g. QFI) identifying a data flow and information (e.g. 5QI) identifying a Quality of Service (QoS) associated with the data flow for determining a first channel access priority class (CAPC) value for the data flow; receiving a data packet and information identifying the data flow to which the data packet belongs; processing the data packet to form a Transport Block for transmission via the unlicensed spectrum; and determining a second CAPC value for the Transport Block based on the information identifying the data flow and the information identifying the QoS associated with the data flow.

In one example aspect, the invention provides a method performed by a communication apparatus for a channel access procedure relating to communication via an unlicensed spectrum, the method comprising: determining a respective channel access priority class (CAPC) value for each of a plurality of data flows based on a mapping between Quality of Service (QoS) identifiers and corresponding CAPC values; mapping a first data flow to a data radio bearer (DRB) and configuring a first CAPC value for the DRB based on the mapping and a QoS identifier associated with the first data flow; and mapping a second data flow to the DRB when a QoS identifier associated with the second data flow can be mapped to the first CAPC, or mapping the second data flow to a different DRB when the QoS identifier associated with the second data flow can be mapped to a different CAPC value.

In one example aspect, the invention provides a communication apparatus for a channel access procedure relating to communication via an unlicensed spectrum, the communication apparatus comprising: means (e.g. a transceiver circuit) for receiving a data packet forming part of a data flow and forwarding the data packet to a lower layer together with information identifying a first channel access priority class (CAPC) value for the data flow; means (e.g. a processor) for processing the data packet, at the lower layer, to form a Transport Block for transmission via the unlicensed spectrum; and means (e.g. a processor) for determining a second CAPC value for the Transport Block based on the information identifying the first CAPC value.

In one example aspect, the invention provides an apparatus configured as a central unit of a base station for a channel access procedure relating to communication via an unlicensed spectrum, the apparatus comprising: means (e.g. a transceiver circuit) for receiving a data packet forming part of a data flow; and means (e.g. a transceiver circuit) for forwarding, to a distributed unit handling lower layer processing of the data flow, the data packet together with information identifying a first channel access priority class (CAPC) value for the data flow.

In one example aspect, the invention provides an apparatus configured as a distributed unit of a base station apparatus for a channel access procedure relating to communication via an unlicensed spectrum, the apparatus comprising: means (e.g. a transceiver circuit) for receiving, from a central unit of the base station apparatus, a data packet forming part of a data flow, together with information identifying a first channel access priority class (CAPC) value for the data flow;

means (e.g. a processor) for processing the data packet to form a Transport Block for transmission via the unlicensed spectrum; and means (e.g. a processor) for determining a second CAPC value for the Transport Block based on the information identifying the first CAPC value.

In one example aspect, the invention provides an apparatus configured as a distributed unit of a base station apparatus for a channel access procedure relating to communication via an unlicensed spectrum, the apparatus comprising: means (e.g. a transceiver circuit) for receiving, from the central unit, information (e.g. QFI) identifying a data flow and information (e.g. 5QI) identifying a Quality of Service (QoS) associated with the data flow for determining a first channel access priority class (CAPC) value for the data flow; means (e.g. a transceiver circuit) for receiving a data packet and information identifying the data flow to which the data packet belongs; means (e.g. a processor) for processing the data packet to form a Transport Block for transmission via the unlicensed spectrum; and means (e.g. a processor) for determining a second CAPC value for the Transport Block based on the information identifying the data flow and the information identifying the QoS associated with the data flow.

In one example aspect, the invention provides a communication apparatus for a channel access procedure relating to communication via an unlicensed spectrum, the communication apparatus comprising: means (e.g. a processor) for determining a respective channel access priority class (CAPC) value for each of a plurality of data flows based on a mapping between Quality of Service (QoS) identifiers and corresponding CAPC values; means (e.g. a processor) for mapping a first data flow to a data radio bearer (DRB) and configuring a first CAPC value for the DRB based on the mapping and a QoS identifier associated with the first data flow; and means (e.g. a processor) for mapping a second data flow to the DRB when a QoS identifier associated with the second data flow can be mapped to the first CAPC, or for mapping the second data flow to a different DRB when the QoS identifier associated with the second data flow can be mapped to a different CAPC value.

Example aspects of the invention extend to corresponding systems and computer program products such as computer readable storage media having instructions stored thereon which are operable to program a programmable processor to carry out a method as described in the example aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Example embodiments of the invention will now be described, by way of example, with reference to the accompanying drawings in which:

FIG. 1 illustrates schematically a mobile (cellular or wireless) telecommunication system to which example embodiments of the invention may be applied;

FIG. 2 is a block diagram of a User Equipment (UE) forming part of the system shown in FIG. 1;

FIG. 3 is a block diagram of a base station (gNB) forming part of the system shown in FIG. 1;

FIG. 4 is a block diagram of a core network node (or function) forming part of the system shown in FIG. 1;

FIG. 5 illustrates schematically some examples of assigning respective Channel Access Priority Classes in dependence of transmission type; and

FIG. 6 is a schematic diagram illustrating exemplary ways in which example embodiments of the invention can be implemented in the system of FIG. 1.

FIG. 7 is a schematic diagram illustrating exemplary ways in which example embodiments of the invention can be implemented in the system of FIG. 1.

### DESCRIPTION OF EMBODIMENTS

### Overview

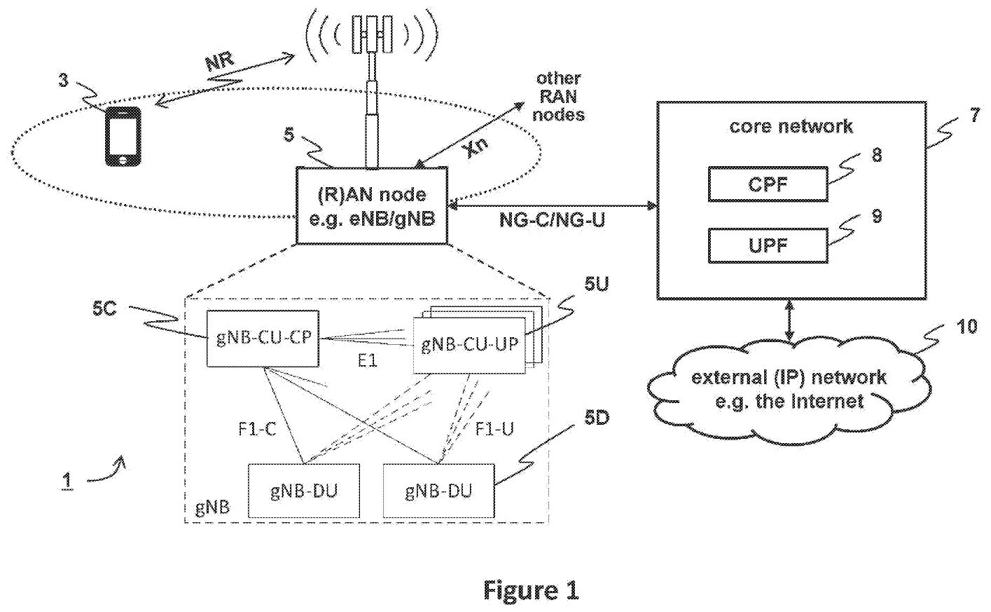

FIG. 1 schematically illustrates a mobile (cellular or wireless) telecommunication system 1 to which example embodiments of the present invention are applicable.

In this network, users of mobile devices 3 (UEs) can communicate with each other and other users via respective base stations 5 and a core network 7 using an appropriate 3GPP radio access technology (RAT), for example, a 5G RAT. It will be appreciated that a number of base stations 5 form a (radio) access network or (R)AN. As those skilled in the art will appreciate, whilst one mobile device 3 and one base station 5 are shown in FIG. 1 for illustration purposes, the system, when implemented, will typically include other base stations and mobile devices (UEs).

Each base station 5 controls one or more associated cells (either directly or via other nodes such as home base stations, relays, remote radio heads, distributed units, and/or the like). A base station 5 that supports Next Generation/5G protocols may be referred to as a ‘gNBs’. It will be appreciated that some base stations 5 may be configured to support both 4G and 5G, and/or any other 3GPP or non-3GPP communication protocols.

It will be appreciated that the functionality of a gNB 5 (referred to herein as a ‘distributed’ gNB) may be split between one or more distributed units (DUs) and a central unit (CU) with a CU typically performing higher level functions and communication with the next generation core and with the DU performing lower level functions and communication over an air interface with UEs in the vicinity (i.e. in a cell operated by the gNB). A distributed gNB includes the following functional units:
gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the F1 interface connected with the gNB-DU.
gNB Distributed Unit (gNB-DU) 5D: a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.
gNB-CU-Control Plane (gNB-CU-CP) 5C: a logical node hosting the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.
gNB-CU-User Plane (gNB-CU-UP) 5U: a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU.

The mobile device 3 and its serving base station 5 are connected via an appropriate air interface (for example the so-called ‘NR’ air interface, the ‘Uu’ interface, and/or the like). Neighbouring base stations 5 are connected to each other via an appropriate base station to base station interface (such as the so-called ‘Xn’ interface, the ‘X2’ interface, and/or the like). The base station 5 is also connected to the core network nodes via an appropriate interface (such as the so-called ‘NG-U’ interface (for user-plane), the so-called ‘NG-C’ interface (for control-plane), and/or the like).

The core network 7 typically includes logical nodes (or ‘functions’) for supporting communication in the telecommunication system 1. Typically, for example, the core network 7 of a ‘Next Generation’/5G system will include, amongst other functions, control plane functions (CPFs) 8 and user plane functions (UPFs) 9. From the core network 7, connection to an external IP network 10 (such as the Internet) may also be provided.

When transmitting data using shared/unlicensed spectrum, the nodes of the system are configured to employ an appropriate LBT procedure before accessing the channel. In case the so-called Type 1 channel access procedure is used, the applicable channel sensing parameters (including contention window size, deferred sensing time, maximum channel occupancy time after channel is sensed to be free) is determined by the channel access priority class (CAPC) of the transmission for which the channel access procedure is running. In other words, for each transmission attempt via the shared/unlicensed spectrum, the LBT parameters are selected based on the CAPC value associated with that transmission.

In this system, for user data transmitted using one or more DRB, CAPC determination is performed at the data flow (QoS flow) level and at transmission level (for each Transport Block). In order to apply the appropriate CAPC for each transmission in accordance with the actual data flow(s) being multiplexed into a Transport Block, the CAPC information is carried together with each packet down through the user plane protocol (e.g. from the IP layer to the MAC layer).

In more detail, the CAPC value for a data flow (QoS flow) is selected/configured by the base station (gNB) 5, e.g. based on the QFI(s)/5QI(s) associated with that data flow. This is typically be performed when setting up the DRB for the data flow(s). When data (IP) packets are processed for that data flow, the CAPC of each packet (i.e. the value mapped from the 5QI of the QoS flow to which the packet belongs) is carried down together with the packet through the user plane protocol (from the IP/SDAP layer to the PDCP, RLC, MAC, and PHY layer). Using the CAPC information, the lower layers (MAC/PHY) are able to dynamically select a CAPC value for each transmission, and select appropriate LTB parameters for channel access, by taking into account the specific QoS requirements for the data packet(s) included in the transmission.

In case of a CU-DU split architecture, the gNB CU-UP 5U may be configured to indicate the CAPC of each data packet to the gNB DU 5D. For example, the gNB CU-UP 5U may include the CAPC value of the packet in the GPRS Tunnelling Protocol User Plane (GTP-U) encapsulation header for the downlink user plane packets sent on the F1-U interface. In this case, the gNB DU 5U can consider the received CAPC value when scheduling/multiplexing the data into a transmission.

Beneficially, in this system it is possible to apply the appropriate CAPC value at the transmission level for each data packet in accordance with the CAPC value configured at the QoS flow level.

### Mobile Device

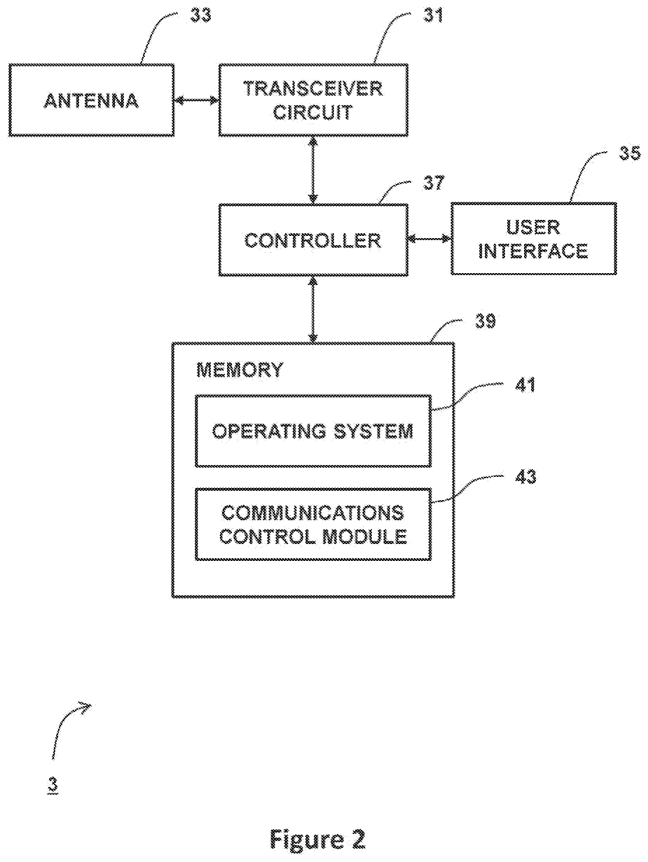

FIG. 2 is a block diagram illustrating the main components of the mobile device 3 shown in FIG. 1 (e.g. a mobile telephone or an IoT device). As shown, the mobile device 3 has a transceiver circuit 31 that is operable to transmit signals to and to receive signals from a base station 5 via one or more antenna 33. The mobile device 3 has a controller 37 to control the operation of the mobile device 3. The controller 37 is associated with a memory 39 and is coupled to the transceiver circuit 31. Although not necessarily required for its operation, the mobile device 3 might of course have all the usual functionality of a conventional mobile telephone (such as a user interface 35) and this may be provided by any one or any combination of hardware, software and firmware, as appropriate. Software may be pre-installed in the memory 39 and/or may be downloaded via the telecommunications network or from a removable data storage device (RMD), for example.

The controller 37 is configured to control overall operation of the mobile device 3 by, in this example, program instructions or software instructions stored within memory 39. As shown, these software instructions include, among other things, an operating system 41, and a communications control module 43.

The communications control module 43 is operable to control the communication between the mobile device 3 and its serving base station 5 (and other communication devices connected to the serving base station 5, such as other user equipment, core network nodes, etc.).

It will be appreciated that the communications control module 43 may include a number of sub-modules (or ‘layers’) to support specific functionalities. For example, the communications control module 43 may include a Listen-Before-Talk (LBT) sub-module, a Channel Access Priority Class (CAPC) sub-module, a Physical (PHY) layer sub-module, a Medium Access Control (MAC) sub-module, a Radio Link Control (RLC) sub-module, a Packet Data Convergence Protocol (PDCP) sub-module, a Service Data Adaptation Protocol (SDAP) sub-module, an Internet Protocol (IP) sub-module, a Radio Resource Control (RRC) sub-module, a Non-Access Stratum (NAS) sub-module, etc.

If present, the LBT sub-module is responsible for performing listen-before-talk communications using shared spectrum, and associated control signalling (e.g. for configuring the mobile device 3 for LBT operation). The LBT sub-module may be configured to apply appropriate channel sensing parameters (e.g. contention window size, deferred sensing time, maximum channel occupancy time after the channel is sensed to be free) for a particular transmission based on the associated CAPC value.

The CAPC sub-module is responsible for applying the appropriate CAPC value for each DRB, in accordance with the QoS flow(s) mapped to that DRB.

The RRC sub-module is operable to generate, send and receive signalling messages formatted according to the RRC standard. Such messages are exchanged between the mobile device 3 and its serving base station 5. The RRC messages may include, for example, information identifying a CAPC value for a DRB.

### Base Station

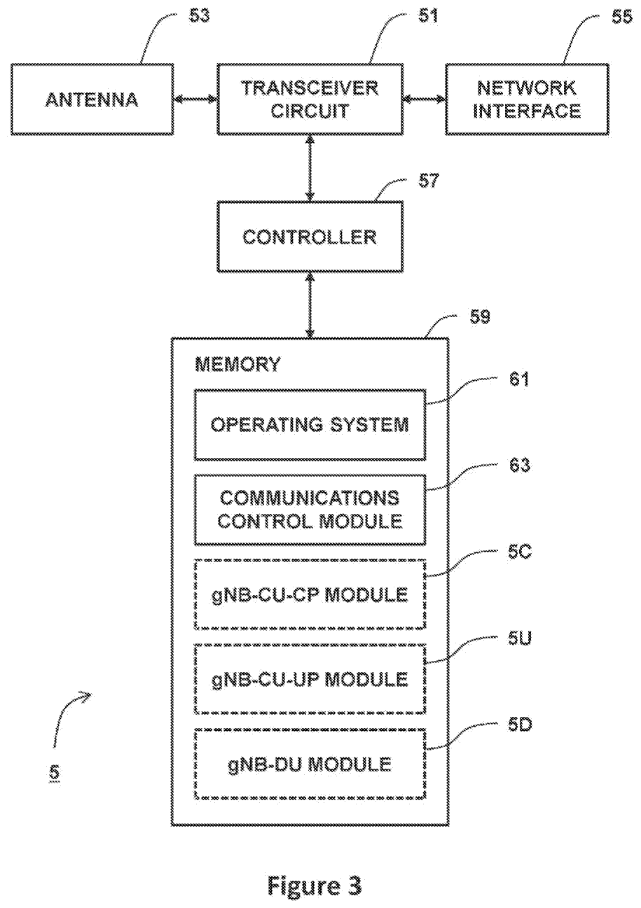

FIG. 3 is a block diagram illustrating the main components of a base station 5 shown in FIG. 1. As shown, the base station 5 has a transceiver circuit 51 for transmitting signals to and for receiving signals from user equipment (such as the mobile device 3) via one or more antenna 53, a network interface 55 (e.g. NG-C/NG-U interface, and/or the like) for transmitting signals to and for receiving signals from the core network 7, and a base station interface 56 (e.g. Xn interface, and/or the like) for transmitting signals to and for receiving signals from neighbouring base stations. The base station 5 has a controller 57 to control the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, and at least a communications control module 63. Although not shown in FIG. 3, the network interface 55 will also typically include a base station to base station interface module (e.g. Xn), and a core network interface module (e.g. NG-C/NG-U).

The communications control module 63 is responsible for handling (generating/sending/receiving) signalling between the base station 5 and other nodes, such as the UE 3 and the core network nodes. Such signalling may include, for example, control data for managing operation of the mobile device 3 (e.g. NAS, RRC, paging, system information, and/or the like). It will be appreciated that the communications control module 63 may include a number of sub-modules (or ‘layers’) to support specific functionalities. For example, the communications control module 63 may include an LBT sub-module, a CAPC sub-module, a PHY sub-module, a MAC sub-module, an RLC sub-module, a PDCP sub-module, an SDAP sub-module, an IP sub-module, an RRC sub-module, etc.

If present, the LBT sub-module is responsible for performing listen-before-talk communications using shared spectrum, and associated control signalling (e.g. for configuring mobile devices 3 for LBT operation). The LBT sub-module may be configured to apply appropriate channel sensing parameters (e.g. contention window size, deferred sensing time, maximum channel occupancy time after the channel is sensed to be free) for a particular transmission based on the associated CAPC value.

The CAPC sub-module is responsible for applying the appropriate CAPC value for each DRB, in accordance with the QoS flow(s) mapped to that DRB.

The RRC sub-module is operable to generate, send and receive signalling messages formatted according to the RRC standard. Such messages are exchanged between the base station 5 and the mobile devices 3 served by that base station 5. The RRC messages may include, for example, information identifying a CAPC value for a DRB. When the base station 5 comprises a distributed gNB or en-gNB, the network interface 55 also includes an E1 interface and an F1 interface (F1-C for the control plane and F1-U for the user plane) to communicate signals between respective functions of the distributed gNB or en-gNB. In this case, the software also includes at least one of: a gNB-CU-CP module 5C, a gNB-CU-UP module 5U, and a gNB-DU module 5D. If present, the gNB-CU-CP module 5C hosts the RRC layer and the control plane part of the PDCP layer of the distributed gNB or en-gNB. If present, the gNB-CU-UP module 5U hosts the user plane part of the PDCP and the SDAP layers of the distributed gNB or the user plane part of the PDCP layer of the distributed en-gNB. If present, the gNB-DU module 5D hosts the RLC, MAC, and PHY layers of the distributed gNB or en-gNB.

It will be understood by a person skilled in the art that the central unit (e.g. 5C and/or 5U) may be implemented and physically located with the base station or may be implemented at a remote location, as a single physical element or as a cloud-based or virtualised system. It will also be understood that a single central unit may serve multiple base stations 5.

### Core Network Node

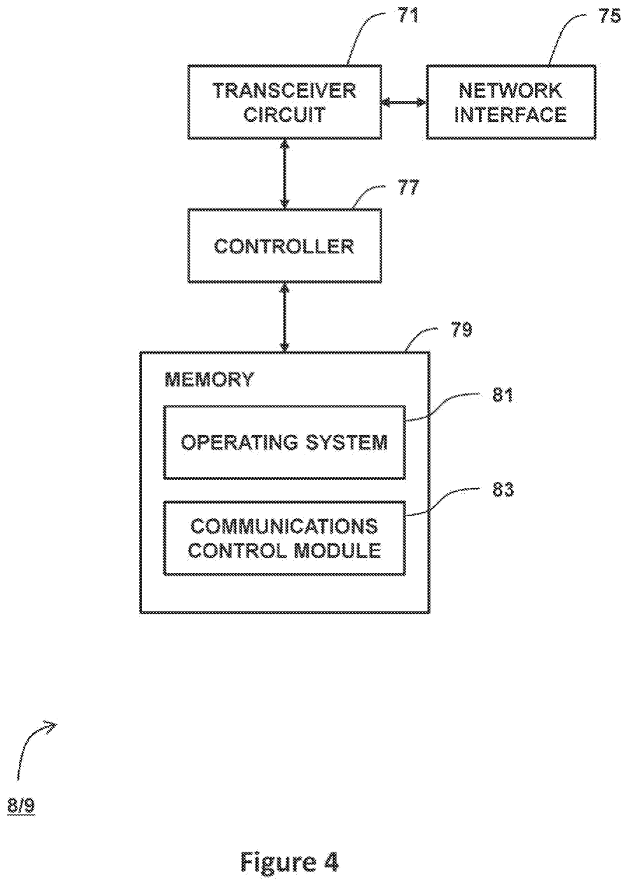

FIG. 4 is a block diagram illustrating the main components of a generic core network node (or function) shown in FIG. 1, for example, the CPF 8 or the UPF 9. As shown, the core network node includes a transceiver circuit 71 which is operable to transmit signals to and to receive signals from other nodes (including the UE 3 and the (R)AN node 5) via a network interface 75. A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81 and at least a communications control module 83. The communications control module 83 is responsible for handling (generating/sending/ receiving) signaling between the core network node and other nodes, such as the UE 3, the (R)AN node 5, and other core network nodes.

### Operation

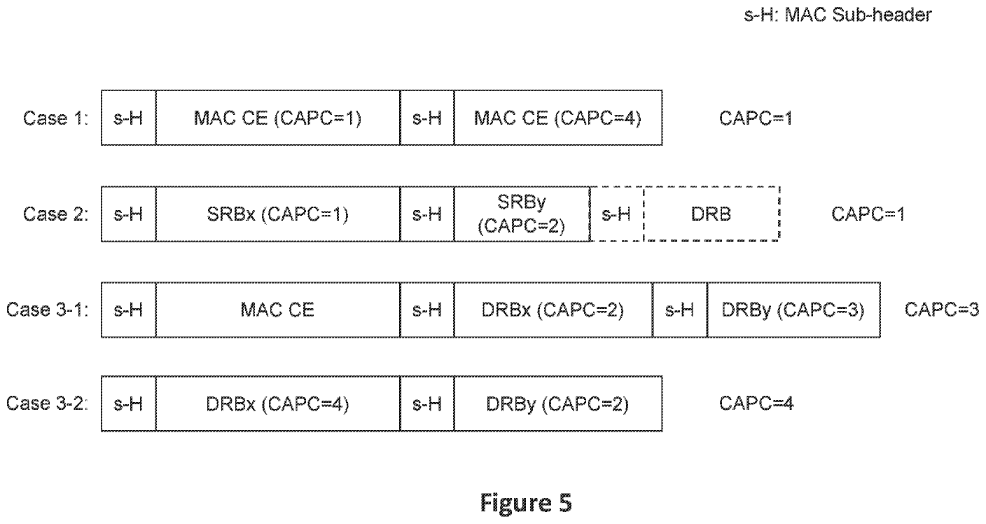

A more detailed description will now be given (with reference to FIGS. 5 to 7) of various ways in which CAPC mapping may be performed in the system shown in FIG. 1.

When a DRB is set up for a mobile device 3, the base station 5 (using its CAPC sub-module) may be configured to determine an appropriate CAPC value for the DRB based on the Quality of Service (QoS) required for the data flow(s) carried by that DRB. Each data flow has an associated QoS Flow Identifier (QFI), e.g. 5G QoS Identifier (5QI), and the CAPC for each DRB may be determined based on the 5QI value(s) of the QoS flows in that DRB. Table 1 illustrates a possible way for mapping 5QI values to appropriate CAPS values.

TABLE 1
CAPC value per QoS flow (5QI)

| | Channel Access |
|---|---|
| 5QI of Data Flows | Priority Class (p) |
| 1, 3, 5, 65, 66, 67, 69, 70, | 1 |
| 79, 80, 82, 83, 84, 85 | |
| 2, 7, 71 | 2 |
| 4, 6, 8, 9, 72, 73, 74, 76 | 3 |
| None | 4 |

If a DRB is set up for more than one QoS flow, each QoS flow may have a different associated 5QI value which maps to a different CAPC value. In this case, under the current 3GPP standards, it is up to the base station 5 to select an appropriate CAPC value for the DRB (considering the respective 5QIs of all the QoS flows multiplexed in that DRB while considering fairness between different traffic types and transmissions). Accordingly, when the current DRB level mapping is used, a QoS flow in a DRB may be mapped to a different CAPC value than the one assigned for its 5QI in Table 1.

When the base station 5 decides the CAPC applicable for a bearer (DRB or SRB), the base station 5 configures the mobile device 3 to use that CAPC value for its uplink transmissions over that bearer. In accordance with the current 3GPP standards, such configuration may use RRC signalling. Effectively, this is a static configuration which does not change at least until the QoS flows included in the DRB change (e.g. a QoS flow is added or removed).

As illustrated in FIG. 5, transmissions (‘Transport Blocks’) on PUSCH/PDSCH may include one or more of the following: control plane data from one or more SRB (e.g. RRC signalling); user plane data from one or more DRB (e.g. IP packets); and one or more MAC CE. The data from the various SRB/DRB/MAC CE(s) are multiplexed into Transport Blocks for transmission after processing at the various layers (in this example, SDAP, PDCP, RLC, and MAC layer). For uplink transmissions, the mobile device 3 (lower layer i.e. PHY/MAC) follows the rules below in order to determine the applicable CAPC of a particular transmission based on the kind of data being multiplexed into that transmission (the base station 5 uses similar rules for downlink transmissions):
Case 1: Highest priority CAPC of MAC CE(s) if only MAC CE(s) are included;
Case 2: Highest priority CAPC of SRBs if SRB SDU(s) are included; and
Case 3: Lowest priority CAPC of the DRBs otherwise.

The CAPC of a transmission (Transport Block) is determined based on the associated CAPC value(s) of the SRB/DRB/MAC CE forming part of that transmission, as shown in Table 2 below.

TABLE 2
CAPC value per transmission type

| | Channel Access |
|---|---|
| DRB/SRB/MAC CE | Priority Class (p) |
| SRB0 | 1 |
| SRB1 | 1 |
| SRB2 | Selected/configured by gNB |
| SRB3 | 1 |
| MAC CE: padding BSR and | 4 |
| recommended bit rate MAC | |
| C6tEs | |
| MAC CE: other than padding BSR | 1 |
| and recommended bit rate MAC | |
| CEs | |
| DRBs: mapping from data flows | Selected/configured by gNB |
| | (Table 1) |

FIG. 5 illustrates four examples in accordance to Cases 1 to 3 described above, using the rules currently defined by 3GPP. In the first example (‘Case 1’), two types of MAC CEs are multiplexed into a Transport Block, having different CAPC values (CAPC=4 for a padding BSR or recommended bit rate MAC CE and CAPC=1 for other MAC CE). The final CAPC value for the Transport Block in this case is set to the lower value (i.e. higher priority). In case 2, Service Data Units (SDUs) from two SRBs having different CAPC values are multiplexed into a Transport Block (optionally with one or more DRB). The final CAPC value for the Transport Block in case 2 is set to the lower one of the SRB specific CAPC values (i.e. higher priority). In cases 3-1 and 3-2, two different DRBs with different CAPC values are multiplexed into a Transport Block (and additionally with a MAC CE in case 3-1). The final CAPC values for the Transport Blocks in cases 3-1 and 3-2 are set to the higher one of the DRB specific CAPC values (i.e. lower priority).

As can be seen, therefore, when multiplexing a particular DRB into a Transport Block (e.g. with any other DRB/SRB/MAC CE), the current transmission level mapping may also result in a CAPC value that is different to the one configured for that DRB based on the associated QFI/5QI of the relevant QoS flow. Moreover, as explained above, the DRB level (static) CAPC mapping may also assign a different CAPC value to data packets from some QoS flows than the value mapped to the QFI of those flows. As a result of this inconsistency in CAPC mapping, when attempting to transmit a Transport Block using unlicensed/shared spectrum, the base station 5 and the mobile device 3 may perform a channel access procedure using different LBT parameters than the parameters expected for the data included in that Transport Block.

In this system, in order to apply the appropriate CAPC for each transmission in accordance with the actual data flow(s) being multiplexed into a Transport Block, the communication control modules 43 and 63 of the mobile device 3 and the base station 5 are configured to carry the CAPC information together with each packet down through the user plane protocol.

In more detail, for each data flow (QoS flow), the associated CAPC value is determined based on the QFI(s)/5QI(s) as shown in Table 1. This happens prior to the multiplexing step at lower layers, for example, when setting up the DRB for the data flow(s).

When data (IP) packets are processed through the user plane protocol from the SDAP to the PDCP, RLC, MAC, and PHY layers (by the corresponding sub-modules of the communication control modules 43 and 63), the CAPC of each packet (i.e. the value mapped from the 5QI of the QoS flow to which the packet belongs) is carried down together with the packet. It will be appreciated that each layer may add appropriate information to the data packets relating to the CAPC value associated with that data packet (i.e. the CAPC of the corresponding QoS flow). This information may comprise the actual CAPC value or any other suitable information that can be used for deriving, at a lower layer, the CAPC value for a given data packet. If appropriate, the information may be different in each layer (i.e. layer specific CAPC information may be used).

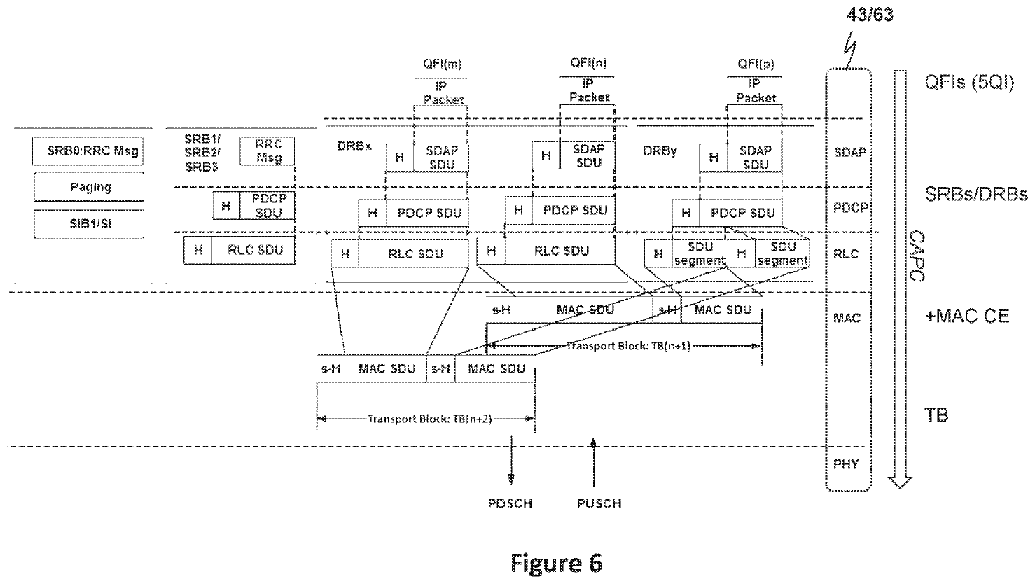

In the example shown in FIG. 6, there are two DRBs (denoted ‘DRBx’ and ‘DRBy’) with one or more associated QoS flow. In this example, DRBx includes two QoS flows (denoted ‘QFI(m)’ and ‘QFI(n)’) with their own associated 5QI values (or no 5QI value) and DRBy includes one QoS flow (‘QFI(p)’). Thus, the base station 5 and the mobile device 3 can determine an appropriate CAPC value for each QoS flow and each data packet in the QoS flows, in accordance with the associated 5QI (e.g. CAPC values ‘1’ to ‘3’ for the 5QI values shown in Table 1, and CAPC value ‘4’ for those QoS flows that do not have an associated 5QI value).

Beneficially, for a transmission that includes user plane data from different QoS flows with different QoS requirements (QFI/5Q1 values), it is possible to dynamically determine the CAPC value to be used for each data packet at the MAC/PHY layer based on the actual CAPC of the corresponding QoS flow (rather than an average or arbitrary CAPC value assigned at DRB level).

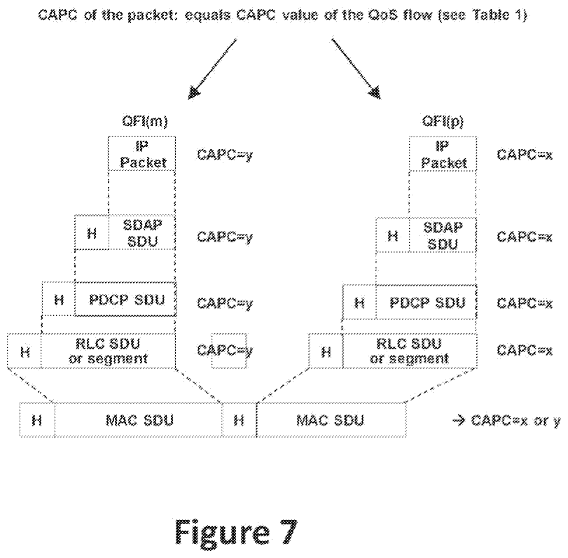

FIG. 7 illustrates the processing of data packets from two QoS flows, QFI(m) and QFI(p). As shown in FIG. 6, QFI(m) and QFI(p) belong to different DRBs. However, Transport Block ‘TB(n+2)’ includes data from both QoS flows. The respective CAPC values for QFI(m) and QFI(p) are indicated for each lower layer, from upper layers, in order to allow a more accurate (and dynamic) determination of the applicable CAPC value (and corresponding LBT parameters) at the MAC/PHY layer, compared to the case when DRB specific CAPC values are used. Since the CAPC selection at the MAC/PHY layer does not rely on DRB level CAPC selection, it is not necessary to use the same CAPC value for all data flows in a DRB (i.e. QFI(n) and QFI(m) in DRBx), which improves the way in which Transport Blocks are generated and transmitted using unlicensed spectrum.

Beneficially, when using the above described data flow specific CAPC indication, there is no need to map and configure the CAPC of a DRB over the RRC (or F1) interface.

In the case of multiple QoS flows being mapped into one DRB, the information used by lower layer for CAPC selection for a transmission is more accurate and it does not require converting the respective CAPC values of multiple QoS flows into a single CAPC at the DRB level.

It will be appreciated that the above described method is applicable at the base station side (for downlink transmission) without change in 3GPP specifications, and it is also applicable at the UE side (for uplink transmission) with relatively minor changes to the current specifications.

### CU-DU Split Architecture—Option 1

In case of a CU-DU split architecture, the CAPC values may be indicated per data packet on the downlink. In this case, the gNB CU (gNB CU-UP 5U) may be configured to indicate the CAPC of each packet to the gNB DU 5D. For example, the gNB CU-UP 5U may include the CAPC value of the packet in the GPRS Tunnelling Protocol User Plane (GTP-U) encapsulation header for the downlink user plane packets sent on the F1-U interface. For example, a PDU Session Container or any other suitable (new or existing) extension header type may be used to indicate the CAPC value of the packet. The gNB DU 5D may be configured to take into consideration the received CAPC indicator when scheduling/multiplexing the data into a transmission.

Thus, effectively, in this case the CAPC information (GTP-U header and/or the like) is carried together with each packet down through the user plane protocol, from the central unit of the base station 5 (upper layer) to the distributed unit (lower layer, e.g. PHY/MAC). Beneficially, based on the received the CAPC information, the distributed unit (gNB DU 5D) is able to apply the appropriate CAPC value and LBT configuration for each transmission in accordance with the actual data flow(s) being multiplexed into the Transport Blocks (and regardless of any CAPC value associated with the DRB to which the multiplexed data packets belong).

### CU-DU Split Architecture—Option 2

In this option, the gNB DU 5D (lower layer) may receive, for each DRB, the following information from the gNB CU-CP 5C via the F1-C interface:
QoS flows mapped to the DRB; and
QoS information of each QoS flow including a QoS flow identifier (QFI), 5QI.

The lower layer (e.g. PHY/MAC) will inspect each packet received from upper layer and determines which QFI the packet belongs to. For example, the determination of the QFI may be based on the following methods:
establishing a separate tunnel for each QoS flow/QFI; or
marking each packet with the associated QFI.

When a data packet (the whole packet or a part of it) is multiplexed into a transmission, the CAPC of this data packet can be mapped from the 5QI of the QoS flow/tunnel that the packet belongs to, for example, based on the mapping shown in Table 1.

The CAPC of each transmission can be determined by taking into account the CAPC/5QI of all data packets being multiplexed into that transmission, following the rules described above with reference to FIG. 5 (using the CAPC of the packet instead of CAPC of DRB).

Thus, in this case, the CAPC information may be provided in the form of a QFI with each received data packet and/or information (e.g. a tunnel ID) identifying the tunnel via which the data packet is transmitted (the tunnel ID being associated with a particular QoS flow or QFI). Effectively, this information is carried together with each packet down through the user plane protocol, from the central unit of the base station 5 (upper layer) to the distributed unit (lower layer, e.g. PHY/MAC). Based on the received the CAPC information (tunnel ID/QFI), the distributed unit (gNB DU 5D) is able to apply the appropriate CAPC value/LBT parameters for each transmission in accordance with the actual data flow(s) being multiplexed into the Transport Blocks (and regardless of any CAPC associated with the DRB to which the multiplexed data packets belong).

### DRB Level CAPC Selection

When DRB level CAPC selection is employed, the base station 5 may be configured to apply one of the following options to determine the most appropriate CAPC value for each DRB.

The base station 5 may be configured to apply a one-to-one QoS flow to DRB mapping (as for DRBy in FIG. 6). In this case, the DRB level CAPC value corresponds to the QoS flow specific CAPC. In a variation of this option, the base station 5 may be configured to map only those QoS flows into the same DRB that have the same CAPC value which would make CAPC selection easier at the lower layers.

When multiple QoS flows are mapped to a single DRB (as for DRBx in FIG. 6), and the QoS flows have different associated CAPC values (based on their SQIs), the base station 5 may be configured to select the lowest priority CAPC of all QoS flows. Although it may cause extra delay for a transmission carrying data from a relatively higher priority QoS flow in that DRB, this will result in the base station and the UE acting as a ‘friendly’ neighbour for other nodes operating on the shared channel.

It will be appreciated that in case there is a ‘dominant’ QoS flow in a DRB, the CAPC value for the DRB may be set to that of the dominant QoS flow. When determining whether any QoS flow can be classified as a dominant flow, the base station 5 may be configured to consider any available information related to that QoS flow, for example, whether the QoS flow is likely to carry a relatively large amount of data and/or be relatively more active than other QoS flows in the same DRB.

### Modifications and Alternatives

Detailed example embodiments have been described above. As those skilled in the art will appreciate, a number of modifications and alternatives can be made to the above example embodiments whilst still benefiting from the inventions embodied therein. By way of illustration only a number of these alternatives and modifications will now be described.

In the above description, the UE, the (R)AN node, and the core network node are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE, the (R)AN node, and the core network node as a signal over a computer network, or on a recording medium. Further, the functionality performed by part or all of this software may be performed using one or more dedicated hardware circuits. However, the use of software modules is preferred as it facilitates the updating of the UE, the (R)AN node, and the core network node in order to update their functionalities.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.). A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IoT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: 3GPP TS 22.368 V13.1.0, Annex B, the contents of which are incorporated herein by reference). This list is not exhaustive and is intended to be indicative of some examples of machine type communication applications.

TABLE 3

| Service Area | MTC applications |
|---|---|
| Security | Surveillance systems |
| | Backup for landline |
| | Control of physical access (e.g. to |
| | buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service, an emergency radio communication system, a Private Branch eXchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VoLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and example embodiments described in the present document. Needless to say, these technical ideas and example embodiments are not limited to the above-described UE and various modifications can be made thereto.

The above described method may further comprise determining the first CAPC value based on information (e.g. 5QI) identifying a Quality of Service (QoS) associated with the data flow.

The Transport Block may be formed by multiplexing at least a part of the data packet and further data, and wherein the second CAPC value is determined based on the information identifying the first CAPC value and a further CAPC value associated with the further data.

The information identifying the first CAPC value may be generated at a Radio Link Control (RLC) layer, a Packet Data Convergence Protocol (PDCP) layer, a Service Data Adaptation Protocol (SDAP) layer, an Internet Protocol (IP) layer, or a Radio Resource Control (RRC) layer. The determining a second CAPC value may be performed at a Medium Access Control (MAC) layer.

The above described method may further comprise performing a channel access procedure based on the second CAPC for the Transport Block.

The data flow may comprise a QoS flow. The data flow may be carried by a data radio bearer (DRB) having an associated CAPS value, different to the first CAPS value. The information identifying the data flow may comprise information identifying a tunnel (e.g. a tunnel ID).

The above described communication apparatus may comprise a user equipment (UE) or a base station apparatus (gNB). The base station apparatus may comprise a central unit and at least one distributed unit, and the central unit may forward the data packet together with information identifying the first CAPC value to the at least one distributed unit handling the lower layer.

Various other modifications will be apparent to those skilled in the art and will not be described in further detail here.

The whole or part of the example embodiments disclosed above can be described as, but not limited to, the following supplementary notes.

### Supplementary Note 1

A method performed by a communication apparatus for a channel access procedure relating to communication via an unlicensed spectrum, the method comprising:
receiving a data packet forming part of a data flow and forwarding the data packet to a lower layer together with information identifying a first channel access priority class (CAPC) value for the data flow;
processing the data packet, at the lower layer, to form a Transport Block for transmission via the unlicensed spectrum; and
determining a second CAPC value for the Transport Block based on the information identifying the first CAPC value.

### Supplementary Note 2

The method according to supplementary note 1, further comprising determining said first CAPC value based on information (e.g. 5QI) identifying a Quality of Service (QoS) associated with the data flow.

### Supplementary Note 3

The method according to supplementary note 1 or 0, wherein said Transport Block is formed by multiplexing at least a part of said data packet and further data, and wherein the second CAPC value is determined based on the information identifying the first CAPC value and a further CAPC value associated with said further data.

### Supplementary Note 4

The method according to any of supplementary notes 0 to 0, wherein the information identifying the first CAPC value is generated at a Radio Link Control (RLC) layer, a Packet Data Convergence Protocol (PDCP) layer, a Service Data Adaptation Protocol (SDAP) layer, an Internet Protocol (IP) layer, or a Radio Resource Control (RRC) layer.

### Supplementary Note 5

The method according to any of supplementary notes 0 to 0, wherein said determining a second CAPC value is performed at a Medium Access Control (MAC) layer.

### Supplementary Note 6

The method according to any of supplementary notes 0 to 0, further comprising performing a channel access procedure based on the second CAPC for the Transport Block.

### Supplementary Note 7

The method according to any of supplementary notes 0 to 0, wherein the data flow comprises a QoS flow.

### Supplementary Note 8

The method according to any of supplementary notes 0 to 0, wherein the data flow is carried by a data radio bearer (DRB) having an associated CAPS value, different to the first CAPS value.

### Supplementary Note 9

The method according to any of supplementary notes 0 to 0, wherein the communication apparatus comprises a user equipment (UE).

### Supplementary Note 10

The method according to any of supplementary notes 0 to 0, wherein the communication apparatus comprises a base station apparatus (gNB).

### Supplementary Note 11

The method according to supplementary note 0, wherein the communication apparatus comprises a central unit and at least one distributed unit, and the central unit forwards the data packet together with information identifying the first CAPC value to the at least one distributed unit handling said lower layer.

### Supplementary Note 12

A method performed by a central unit of a base station apparatus for a channel access procedure relating to communication via an unlicensed spectrum, the method comprising:
receiving a data packet forming part of a data flow; and
forwarding, to a distributed unit handling lower layer processing of the data flow, the data packet together with information identifying a first channel access priority class (CAPC) value for the data flow.

### Supplementary Note 13

A method performed by a distributed unit of a base station apparatus for a channel access procedure relating to communication via an unlicensed spectrum, the method comprising:
receiving, from a central unit of the base station apparatus, a data packet forming part of a data flow, together with information identifying a first channel access priority class (CAPC) value for the data flow;
processing the data packet to form a Transport Block for transmission via the unlicensed spectrum; and
determining a second CAPC value for the Transport Block based on the information identifying the first CAPC value.

### Supplementary Note 14

A method performed by a distributed unit of a base station apparatus for a channel access procedure relating to communication via an unlicensed spectrum, the method comprising:
receiving, from the central unit, information (e.g. QFI) identifying a data flow and information (e.g. 5QI) identifying a Quality of Service (QoS) associated with the data flow for determining a first channel access priority class (CAPC) value for the data flow;
receiving a data packet and information identifying the data flow to which the data packet belongs;
processing the data packet to form a Transport Block for transmission via the unlicensed spectrum; and
determining a second CAPC value for the Transport Block based on the information identifying the data flow and the information identifying the QoS associated with the data flow.

### Supplementary Note 15

The method according to supplementary note 0, wherein the information identifying the data flow comprises information identifying a tunnel (e.g. a tunnel ID).

### Supplementary Note 16

A method performed by a communication apparatus for a channel access procedure relating to communication via an unlicensed spectrum, the method comprising:
determining a respective channel access priority class (CAPC) value for each of a plurality of data flows based on a mapping between Quality of Service (QoS) identifiers and corresponding CAPC values;
mapping a first data flow to a data radio bearer (DRB) and configuring a first CAPC value for the DRB based on said mapping and a QoS identifier associated with the first data flow; and
mapping a second data flow to the DRB when a QoS identifier associated with the second data flow can be mapped to the first CAPC, or mapping the second data flow to a different DRB when the QoS identifier associated with the second data flow can be mapped to a different CAPC value.

### Supplementary Note 17

A communication apparatus for a channel access procedure relating to communication via an unlicensed spectrum, the communication apparatus comprising:
means for receiving a data packet forming part of a data flow and forwarding the data packet to a lower layer together with information identifying a first channel access priority class (CAPC) value for the data flow;
means for processing the data packet, at the lower layer, to form a Transport Block for transmission via the unlicensed spectrum; and
means for determining a second CAPC value for the Transport Block based on the information identifying the first CAPC value.

### Supplementary Note 18

An apparatus configured as a central unit of a base station for a channel access procedure relating to communication via an unlicensed spectrum, the apparatus comprising:
means for receiving a data packet forming part of a data flow; and
means for forwarding, to a distributed unit handling lower layer processing of the data flow, the data packet together with information identifying a first channel access priority class (CAPC) value for the data flow.

### Supplementary Note 19

An apparatus configured as a distributed unit of a base station apparatus for a channel access procedure relating to communication via an unlicensed spectrum, the apparatus comprising:
means for receiving, from a central unit of the base station apparatus, a data packet forming part of a data flow, together with information identifying a first channel access priority class (CAPC) value for the data flow;
means for processing the data packet to form a Transport Block for transmission via the unlicensed spectrum; and
means for determining a second CAPC value for the Transport Block based on the information identifying the first CAPC value.

### Supplementary Note 20

An apparatus configured as a distributed unit of a base station apparatus for a channel access procedure relating to communication via an unlicensed spectrum, the apparatus comprising:
means for receiving, from the central unit, information (e.g. QFI) identifying a data flow and information (e.g. 5QI) identifying a Quality of Service (QoS) associated with the data flow for determining a first channel access priority class (CAPC) value for the data flow;
means for receiving a data packet and information identifying the data flow to which the data packet belongs;
means for processing the data packet to form a Transport Block for transmission via the unlicensed spectrum; and
means for determining a second CAPC value for the Transport Block based on the information identifying the data flow and the information identifying the QoS associated with the data flow.

### Supplementary Note 21

A communication apparatus for a channel access procedure relating to communication via an unlicensed spectrum, the communication apparatus comprising:
means for determining a respective channel access priority class (CAPC) value for each of a plurality of data flows based on a mapping between Quality of Service (QoS) identifiers and corresponding CAPC values;
means for mapping a first data flow to a data radio bearer (DRB) and configuring a first CAPC value for the DRB based on said mapping and a QoS identifier associated with the first data flow; and
means for mapping a second data flow to the DRB when a QoS identifier associated with the second data flow can be mapped to the first CAPC, or for mapping the second data flow to a different DRB when the QoS identifier associated with the second data flow can be mapped to a different CAPC value.

This application is based upon and claims the benefit of priority from United Kingdom Patent Application No. 2014353.3, filed on Sep. 11, 2020, the disclosure of which is incorporated herein in its entirety by reference.

1-21. (canceled)

22. A method performed by a communication apparatus for a channel access procedure relating to communication via an unlicensed spectrum, the method comprising:
receiving a data packet forming a part of a data flow;
forming a Transport Block from the data packet;
determining a second channel access priority class, CAPC, value for the Transport Block for transmission via the unlicensed spectrum, based on information regarding a first CAPC value for the data flow.

23. The method according to claim 22, wherein
the information regarding the first CAPC value for the data flow includes the first CAPC value.

24. The method according to claim 22, wherein
the information regarding the first CAPC value for the data flow includes information identifying a Quality of Service, QoS, associated with the data flow for determining the first CAPC value for the data flow.

25. The method according to claim 22, wherein
the forming the Transport Block is performed by multiplexing at least a part of the data packet and further data, and
the determining the second CAPC value is performed by determining based on the information identifying the first CAPC value and a further CAPC value associated with the further data.

26. The method according to claim 22, wherein the information identifying the first CAPC value is generated at a Radio Link Control, RLC, layer, a Packet Data Convergence Protocol, PDCP, layer, a Service Data Adaptation Protocol, SDAP, layer, an Internet Protocol, IP, layer, or a Radio Resource Control, RRC, layer.

27. The method according to claim 22, further comprising performing a channel access procedure based on the second CAPC value for the Transport Block.

28. The method according to claim 22, wherein the data flow is carried by a data radio bearer, DRB, having the second CAPS value, different to the first CAPS value.

29. The method according to claim 22, wherein the communication apparatus includes a user equipment, UE.

30. The method according to claim 22, wherein the communication apparatus includes a base station.

31. The method according to claim 22, wherein
the communication apparatus includes a central unit and at least one distributed unit, and the method further comprises:
forwarding, by the central unit, the data packet together with information identifying the first CAPC value to the at least one distributed unit handling the forming the Transport Block.

32. A method performed by a communication apparatus for a channel access procedure relating to communication via an unlicensed spectrum, the method comprising:
determining a respective channel access priority class, CAPC, value for each of a plurality of data flows based on a mapping between Quality of Service, QoS, identifiers and corresponding CAPC values;
mapping a first data flow to a data radio bearer, DRB;
configuring a first CAPC value for the DRB based on the mapping and a QoS identifier associated with the first data flow; and
mapping a second data flow to the DRB in a case where a QoS identifier associated with the second data flow can be mapped to the first CAPC, or mapping the second data flow to a different DRB in a case where the QoS identifier associated with the second data flow can be mapped to a different CAPC value.

33. A communication apparatus for a channel access procedure relating to communication via an unlicensed spectrum, the communication apparatus comprising:
a memory storing instructions; and
at least one processor configured to process the instructions to:
receive a data packet forming a part of a data flow;
form a Transport Block from the data packet;
determine a second channel access priority class, CAPC, value for the Transport Block for transmission via the unlicensed spectrum, based on information regarding a first CAPC value for the data flow.

34. The communication apparatus according to claim 33, wherein
the information regarding the first CAPC value for the data flow includes the first CAPC value.

35. The communication apparatus according to claim 33, wherein
the information regarding the first CAPC value for the data flow includes information identifying a Quality of Service, QoS, associated with the data flow for determining the first CAPC value for the data flow.

36. A communication apparatus for a channel access procedure relating to communication via an unlicensed spectrum, the communication apparatus comprising:
a memory storing instructions; and
at least one processor configured to process the instructions to:
determine a respective channel access priority class, CAPC, value for each of a plurality of data flows based on a mapping between Quality of Service, QoS, identifiers and corresponding CAPC values;
map a first data flow to a data radio bearer, DRB;
configure a first CAPC value for the DRB based on the mapping and a QoS identifier associated with the first data flow; and
map a second data flow to the DRB in a case where a QoS identifier associated with the second data flow can be mapped to the first CAPC, or mapping the second data flow to a different DRB in a case where the QoS identifier associated with the second data flow can be mapped to a different CAPC value.
